(19) United States
(12) Patent Application Publication
(10) Pub. No.: US 2018/0319142 A1
(43) Pub. Date: Nov. 8, 2018

(54) POLYETHYLENE-BASED COMPOSITE FILMS, AND ARTICLES MADE THEREFROM

(71) Applicants: Dow Global Technologies LLC, Midland, MI (US); Dow Quimica Mexicana S.A.de C.V., Ciudad De Mexico (MX)

(72) Inventors: Fabricio Arteaga Larios, Sugar Land, TX (US); Eduardo Ruiz, Sugarland, TX (US); Nicolas C. Mazzola, Jundiai (BR); Sabine Alves Da Costa Rossi, Sao Paulo (BR)

(21) Appl. No.: 15/326,099

(22) PCT Filed: Jul. 29, 2015
(86) PCT No.: PCT/US2015/042568

§ 371 Date: Jan. 13, 2017

Related U.S. Application Data
(60) Provisional application No. 62/036,310, filed on Aug. 12, 2014.

(51) Int. Cl. B32B 27/32; B32B 27/08

(52) U.S. Cl. CPC B32B 27/327; B32B 27/08; B32B 2323/043; B32B 2323/046; B32B 2307/718; B32B 2307/72; B32B 2250/03; B32B 2250/242; B32B 2270/00; B32B 2555/02

(57) ABSTRACT

A polyethylene-based composite film comprising a core layer, a first skin layer and a second skin layer, the core layer being positioned between the first skin layer and the second skin layer, wherein the core layer comprises a polymer blend of a high density polyethylene having a density of 0.940-0.970 g/cc and a melt index of 2-10 g/10 min, and a low density polyethylene having a density of 0.910 0.925 g/cc and a melt index of 0.1-1 g/10 min, wherein the first skin layer comprises greater than 50%, by polymer weight of the first skin layer, of an ethylene-based polymer comprising at least 50 wt. % units derived from ethylene, and wherein the ethylene-based polymer has a density of 0.900 0.920 g/cc and a melt index of 1-10 g/10 min, and wherein the polyethylene-based composite film has an overall density of 0.930-0.950 g/cc.

### FIELD

Embodiments of the present disclosure generally relate to polyethylene-based composite films and applications of the polyethylene-based composite films to make articles, such as, for example, laminates, for use in hygiene absorbent products.

### BACKGROUND

In the recent years, it has become increasingly desirable to make thinner hygiene absorbent products, such as, for example, diapers, adult incontinence products, and feminine hygiene articles. This includes reducing the gauge of the cast extruded backsheet films used in hygiene absorbent products, while maintaining the desired strength properties (e.g., stiffness, strength, and ductility) for printing. However, as film thickness is reduced, film stiffness is adversely affected, which can lead to film deformation during the printing process, particularly when the film passes over various printing rolls. Historical approaches to reduce gauge and maintain film stiffness have involved increasing the overall film density by increasing the content of medium density polyethylene or high density polyethylene in the film. Unfortunately, such approaches can result in a loss of physical properties, such as, poor tear strength and films that break easily.

Accordingly, alternative polyethylene-based composite films that can provide decreased film gauge without loss of physical properties are desired.

### SUMMARY

Disclosed in embodiments herein are polyethylene-based composite films comprising a core layer, a first skin layer and a second skin layer, the core layer being positioned between the first skin layer and the second skin layer, wherein the core layer comprises a polymer blend of a high density polyethylene having a density of 0.940-0.970 g/cc and a melt index of 2-10 g/10 min, and a low density polyethylene having a density of 0.910-0.925 g/cc and a melt index of 0.1-1 g/10 min, wherein the first skin layer comprises greater than 50%, by polymer weight of the first skin layer, of an ethylene-based polymer comprising greater than 50 mol. % units derived from ethylene, and wherein the ethylene-based polymer has a density of 0.900-0.920 g/cc and a melt index of 1-10 g/10 min, and wherein the polyethylene-based composite film has an overall density of 0.930-0.950 g/cc. Also disclosed herein are laminate structures comprising the polyethylene-based composite films described herein.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing and the following description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 graphically depicts the 2% secant modulus for polyethylene-based composite films according to one or more embodiments shown and described herein as compared to a comparative film.

FIG. 2 graphically depicts the load at break for polyethylene-based composite films according to one or more embodiments shown and described herein as compared to a comparative film.

FIG. 3 graphically depicts the strain % for polyethylene-based composite films according to one or more embodiments shown and described herein as compared to a comparative film.

FIG. 4 graphically depicts the melt strength for polyethylene-based composite films according to one or more embodiments shown and described herein as compared to a comparative film.

### DETAILED DESCRIPTION

Reference will now be made in detail to embodiments of polyethylene-based composite films and laminate structures, examples of which are further described in the accompanying figures. The polyethylene-based composite films may be used to produce stiff and ductile-like backsheets. It is noted, however, that this is merely an illustrative implementation of the embodiments disclosed herein. The embodiments are applicable to other technologies that are susceptible to similar problems as those discussed above. For example, polyethylene-based composite films used to produce cloth-like wipes, face masks, surgical gowns, tissues, bandages and wound dressings are clearly within the purview of the present embodiments.

In embodiments herein, the polyethylene-based composite films comprise a core layer, a first skin layer and a second skin layer, with the core layer being positioned between the first skin layer and the second skin layer. As used herein in reference to multilayer films, “polyethylene-based” means that the multilayer films are primarily (i.e., greater than 50%, by total weight of the multilayer film) comprised of polyethylene resin. “Polyethylene” refers to a homopolymer of ethylene or a copolymer of ethylene with one or more comonomers with a majority of its polymer units derived from ethylene.

The thickness ratio of the first and second skin layers to the core layer can be a ratio suitable for the end-use application, e.g., diaper backsheet or adult incontinence backsheet. In some embodiments, the thickness ratio of the first and second skin layers to the core layer may be 1:10 to 1:1, 1:5 to 1:1, or 1:4 to 1:1. In other embodiments, the thickness ratio of the first and second skin layers to the core layer may be 4:1 to 1:1, 3:1 to 1:1, 2.5:1 to 1:1 or, 2:1 to 1:1. In some embodiments, the thickness ratio of the first skin layer to the core layer may be 1:5 to 1:1, 1:4 to 1:1.5, or 1:3 to 1:1.5. In some embodiments, the thickness ratio of the second skin layer to the core layer may be 1:5 to 1:1, 1:4 to 1:1.5, or 1:3 to 1:1.5.

The thickness ratio of the first and second skin layers to the core layer can also be captured by percentages. For example, in some embodiments, the core layer comprises from about 40% to about 90% of the overall film thickness. In other embodiments, the core layer comprises from about 50% to about 90% of the overall film thickness. In further embodiments, the core layer comprises from about 60% to about 75% of the overall film thickness. In even further embodiments, the core layer comprises from about 40% to about 65%. In even further embodiments, the first skin layer and the second skin layer independently comprise from about 2% to about 30%, from about 5% to about 30%, or from about 10% to about 30% of the overall film thickness. In embodiments herein, the first and second skin layers may have an equal thickness, or alternatively, may have an unequal thickness.

### Core Layer

The core layer comprises a polymer blend. As used herein, “polymer blend” refers to a mixture of two or more polymers. The polymer blend may be immiscible, miscible, or compatible. In embodiments herein, the polymer blend may comprise at least 70 wt. % of the core layer. In some embodiments, the polymer blend may comprise at least 75 wt. % of the core layer, at least 80 wt. % of the core layer, at least 85 wt. % of the core layer, at least 90 wt. % of the core layer, at least 95 wt. % of the core layer, at least 99 wt. % of the core layer, or at least 100 wt. % of the core layer.

In embodiments herein, the polymer blend may have an overall density of 0.930-0.955 g/cc. All individual values and subranges from 0.930-0.955 g/cc are included and disclosed herein. For example, in some embodiments, the polymer blend has an overall density of 0.930-0.950 g/cc. In other embodiments, the polymer blend has an overall density of 0.933-0.947 g/cc. In further embodiments, the polymer blend has an overall density of 0.935-0.945 g/cc. In even further embodiments, the polymer blend has an overall density of 0.937-0.943 g/cc. Densities disclosed herein are determined according to ASTM D-792.

The polymer blend may have an overall melt index of about 1-10 g/10 min. All individual values and subranges from 1-10 g/10 min are included and disclosed herein. For example, in some embodiments, the polymer blend has a melt index of 1-8 g/10 min. In other embodiments, the polymer blend has a melt index of 1-6 g/10 min. In further embodiments, the polymer blend has a melt index of 3-6 g/10 min. In even further embodiments, the polymer blend has a melt index of 4-6 g/10 min. Melt index, or I₂, is determined according to ASTM D1238 at 190° C., 2.16 kg.

The polymer blend comprises a medium or high density polyethylene (MDPE or HDPE) and a low density polyethylene (LDPE). The MDPE or HDPE present in the polymer blend has a density of about 0.940-0.970 g/cc. All individual values and subranges from 0.940-0.970 g/cc are included and disclosed herein. For example, in some embodiments, the MDPE or HDPE has a density of 0.940-0.965 g/cc. In other embodiments, the MDPE or HDPE has a density of 0.940-0.960 g/cc. In embodiments herein, the MDPE or HDPE present in the polymer blend has a melt index of 1-10 g/10 min. All individual values and subranges from 1-10 g/10 min are included and disclosed herein. For example, in some embodiments, the MDPE or HDPE has a melt index of 2-9 g/10 min. In other embodiments, the MDPE or HDPE has a melt index of 3-8 g/10 min. In further embodiments, the MDPE or HDPE has a melt index of 4-7 g/10 min. In even further embodiments, the MDPE or HDPE has a melt index of 1-6 g/10 min. In even further embodiments, the MDPE or HDPE has a melt index of 1-5 g/10 min.

The MDPE or HDPE may be produced in various commercially available continuous reaction processes, particularly, those comprising two or more individual reactors in series or parallel using slurry, solution or gas phase process technology or hybrid reaction systems (e.g. combination of slurry and gas phase reactor). Exemplary processes may be found in U.S. Pat. No. 4,076,698, which is herein incorporated by reference. Alternatively, the MDPE or HDPE polymers may also be produced by offline blending of 2 or more different polyethylene resins. For example, in some embodiments, a conventional mono-modal Ziegler-Natta MDPE or HDPE may be blended with a multi-modal Ziegler-Natta MDPE or HDPE. It is contemplated, however, that the various HDPE polymers can be produced with alternative catalyst systems, such as, metallocene, post-metallocene or chromium-based catalysts. Exemplary MDPE or HDPE resins may include resins sold by The Dow Chemical Company under the trade name HDPE 8007, HDPE 8907, HDPE 5962B, DMDA 8007 NT 7, AGILITY™ 6047G, DOWLEX™ 2028, DOWLEX™ 2027, or ELITE™ 5960G.

The MDPE or HDPE may be present in the polymer blend in amounts ranging from 40% to 99%, by weight of the polymer blend. All individual values and subranges from 40 to 99 wt. % are included and disclosed herein. For example, in some embodiments, the polymer blend may comprise from 50 to 99%, by weight of the polymer blend, of a medium or high density polyethylene. In other embodiments, the polymer blend may further comprise from 60 to 99%, by weight of the polymer blend, of a medium or high density polyethylene. In further, embodiments, the polymer blend may further comprise from 70 to 99%, by weight of the polymer blend, of a medium or high density polyethylene. In even further, embodiments, the polymer blend may further comprise from 80 to 99%, by weight of the polymer blend, of a medium or high density polyethylene.

The LDPE present in the polymer blend may comprise from 5 to 25%, by weight of the polymer blend, of LDPE. All individual values and subranges from 5 to 25 wt. % are included and disclosed herein. For example, in some embodiments, the polymer blend may comprise from 5 to 23%, by weight of the polymer blend, of LDPE. In other embodiments, the polymer blend may further comprise from 5 to 20%, by weight of the polymer blend, of a low density polyethylene. In further, embodiments, the polymer blend may further comprise from 8 to 20%, by weight of the polymer blend, of a low density polyethylene.

In embodiments herein, the LDPE present in the polymer blend has a density of about 0.910-0.925 g/cc. All individual values and subranges from 0.910-0.925 g/cc are included and disclosed herein. For example, in some embodiments, the LDPE has a density of 0.915-0.925 g/cc. In other embodiments, the LDPE has a density of 0.916-0.922 g/cc. In embodiments herein, the LDPE present in the polymer blend has a melt index of 0.1-2 g/10 min. All individual values and subranges from 0.1-2 g/10 min are included and disclosed herein. For example, in some embodiments, the LDPE has a melt index from 0.1 g/10 min to 1 g/10 min. In other embodiments, the LDPE has a melt index from 0.1 g/10 min to less than 1 g/10 min. In further embodiments, the LDPE has a melt index of 0.2-0.95 g/10 min.

The LDPE may include branched polymers that are partly or entirely homopolymerized or copolymerized in autoclave or tubular reactors at pressures above 14,500 psi (100 MPa) with the use of free-radical initiators, such as peroxides (see for example U.S. Pat. No. 4,599,392, herein incorporated by reference). Examples of suitable LDPEs may include, but are not limited to, ethylene homopolymers, and high pressure copolymers, including ethylene interpolymerized with, for example, vinyl acetate, ethyl acrylate, butyl acrylate, acrylic acid, methacrylic acid, carbon monoxide, or combinations thereof. Exemplary LDPE resins may include resins sold by The Dow Chemical Company, such as, LDPE 132i resins, LDPE 621i resins, LDPE 662i resins, or AGILITY™ 1000 resins. Other exemplary LDPE resins are described in WO 2005/023912, which is herein incorporated by reference.

In some embodiments, the polymer blend may further comprise an optional, linear low density polyethylene (LLDPE). The LLDPE may be present in the polymer blend in amounts ranging from 0% to 50%, by weight of the polymer blend. All individual values and subranges from 0 to 50 wt. % are included and disclosed herein. For example, in some embodiments, the polymer blend may comprise from 0 to 30%, by weight of the polymer blend, of a LLDPE. In other embodiments, the polymer blend may further comprise from 0 to 20%, by weight of the polymer blend, of a LLDPE. In further, embodiments, the polymer blend may further comprise from 0 to 15%, by weight of the polymer blend, of a LLDPE. In even further, embodiments, the polymer blend may further comprise from 0 to 10%, by weight of the polymer blend, of a LLDPE.

The linear low density polyethylene has a polymer backbone that lacks measurable or demonstrable long chain branches. As used herein, “long chain branching” means branches having a chain length greater than that of any short chain branches, which are a result of comonomer incorporation. The long chain branch can be about the same length or as long as the length of the polymer backbone. In some embodiments, the linear low density polyethylene is substituted with an average of from 0.01 long chain branches/1000 carbons to 3 long chain branches/1000 carbons, from 0.01 long chain branches/1000 carbons to 1 long chain branches/1000 carbons, from 0.05 long chain branches/1000 carbons to 1 long chain branches/1000 carbons. In other embodiments, the linear low density polyethylene is substituted with an average of less than 1 long chain branches/1000 carbons, less than 0.5 long chain branches/1000 carbons, or less than 0.05 long chain branches/1000 carbons, or less than 0.01 long chain branches/1000 carbons. Long chain branching (LCB) can be determined by conventional techniques known in the industry, such as ¹³C nuclear magnetic resonance (¹³C NMR) spectroscopy, and can be quantified using, for example, the method of Randall (Rev. Macromol. Chem. Phys., C29 (2 & 3), p. 285-297). Two other methods that may be used include gel permeation chromatography coupled with a low angle laser light scattering detector (GPC-LALLS), and gel permeation chromatography coupled with a differential viscometer detector (GPC-DV). The use of these techniques for long chain branch detection, and the underlying theories, have been well documented in the literature. See, for example, Zimm, B. H. and Stockmayer, W. H., J. Chem. Phys., 17, 1301 (1949) and Rudin A., Modern Methods of Polymer Characterization, John Wiley & Sons, New York (1991), pp. 103-112.

In some embodiments, the linear low density polyethylene may be a homogeneously branched or heterogeneously branched and/or unimodal or multimodal (e.g., bimodal) polyethylene. The linear low density polyethylene comprises ethylene homopolymers, copolymers of ethylene-derived units (“ethylene”) and at least one type of comonomer, and blends thereof. Examples of suitable comonomers may include α-olefins. Suitable α-olefins may include those containing 3 to 20 carbon atoms (C3-C20). For example, the α-olefin may be a C4-C20 α-olefin, a C4-C12 α-olefin, a C3-C10 α-olefin, a C3-C8 α-olefin, a C4-C8 α-olefin, or a C6-C8 α-olefin. In some embodiments, the linear low density polyethylene is an ethylene/α-olefin copolymer, wherein the α-olefin is selected from the group consisting of propylene, 1-butene, 1-pentene, 1-hexene, 4-methyl-1-pentene, 1-heptene, 1-octene, 1-nonene and 1-decene. In other embodiments, the linear low density polyethylene is an ethylene/α-olefin copolymer, wherein the α-olefin is selected from the group consisting of propylene, 1-butene, 1-hexene, and 1-octene. In further embodiments, the linear low density polyethylene is an ethylene/α-olefin copolymer, wherein the α-olefin is selected from the group consisting of 1-hexene and 1-octene. In even further embodiments, the linear low density polyethylene is an ethylene/α-olefin copolymer, wherein the α-olefin is 1-octene. In even further embodiments, the linear low density polyethylene is a substantially linear ethylene/α-olefin copolymer, wherein the α-olefin is 1-octene. In some embodiments, the linear low density polyethylene is an ethylene/α-olefin copolymer, wherein the α-olefin is 1-butene.

The ethylene/α-olefin copolymers may comprise at least 50%, for example, at least 60%, at least 70%, at least 80%, at least 90%, at least 92%, at least 95%, at least 97%, by weight, of the units derived from ethylene; and less than 30%, for example, less than 25%, less than 20%, less than 15%, less than 10%, less than 5%, less than 3%, by weight, of units derived from one or more α-olefin comonomers.

Other examples of suitable linear low density polyethylene include substantially linear ethylene polymers, which are further defined in U.S. Pat. No. 5,272,236, U.S. Pat. No. 5,278,272, U.S. Pat. No. 5,582,923 and U.S. Pat. No. 5,733,155; homogeneously branched linear ethylene polymer compositions, such as those in U.S. Pat. No. 3,645,992; heterogeneously branched ethylene polymers, such as those prepared according to the process disclosed in U.S. Pat. No. 4,076,698; and/or blends thereof (such as those disclosed in U.S. Pat. No. 3,914,342 or U.S. Pat. No. 5,854,045). In some embodiments, the linear low density polyethylene may be a substantially LLDPE polymer, and may include ELITE™ or ATTANE™ resins sold by The Dow Chemical Company, including ELITE™ 5230G resin, ATTANE™ 4404 resin, or ATTANE™ 4202 resin, DOWLEX™ 2247 resin, or EXCEED™ resins sold by Exxon Mobil Corporation, including EXCEED™ 3518 resin or EXCEED™ 4518 resin, AFFINITY™ resins sold by Exxon Mobil Corporation, including AFFINITY™ 1840, and EXACT™ resins sold by Exxon Mobil Corporation, including EXACT™ 3024.

The linear low density polyethylene can be made via gas-phase, solution-phase, or slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof. In some embodiments, gas or slurry phase reactors are used. Suitable linear low density polyethylene may be produced according to the processes described at pages 15-17 and 20-22 in WO 2005/111291 A1, which is herein incorporated by reference. The catalysts used to make the linear low density polyethylene described herein may include Ziegler-Natta, metallocene, constrained geometry, or single site catalysts. In some embodiments, the LLDPE may be a znLLDPE, which refers to linear polyethylene made using Ziegler-Natta catalysts, a uLLDPE or “ultra linear low density polyethylene,” which may include linear polyethylenes made using Ziegler-Natta catalysts, or a mLLDPE, which refers to LLDPE made using metallocene or constrained geometry catalyzed polyethylene.

In embodiments herein, the linear low density polyethylene has a density of 0.900-0.925 g/cc. All individual values and subranges from 0.900-0.925 g/cc are included and disclosed herein. For example, in some embodiments, the linear low density polyethylene has a density of 0.910-0.925 g/cc. In other embodiments, the linear low density polyethylene has a density of 0.900-0.920 g/cc. In further embodiments, the linear low density polyethylene has a density of 0.910-0.920 g/cc. Densities disclosed herein are determined according to ASTM D-792.

In embodiments herein, the linear low density polyethylene has a melt index, or I₂, of 0.1-6 g/10 min. All individual values and subranges from 0.1-6 g/10 min are included and disclosed herein. For example, in some embodiments, the linear low density polyethylene has a melt index of 0.25-5 g/10 min. In other embodiments, the linear low density polyethylene has a melt index of 0.4-4.5 g/10 min. Melt index, or I₂, is determined according to ASTM D1238 at 190° C., 2.16 kg.

In one embodiment, the linear low density polyethylene is a Ziegler-Natta catalyzed ethylene and octene copolymer, having a density from about 0.900 g/cc to about 0.925 g/cc. In another embodiment, the ethylene-based polymer is a single-site catalyzed LLDPE that is multimodal.

In embodiments herein, the polymer blend may be formed by a variety of methods. For example, it may be made by blending or mixing the polymer components together. Blending or mixing can be accomplished by any suitable mixing means known in the art, including melt or dry/physical blending of the individual components. Alternatively, the polymer blend may be made in a single reactor or a multiple reactor configuration, where the multiple reactors may be arranged in series or parallel, and where each polymerization takes place in solution, in slurry, or in the gas phase. It should be understood that other suitable methods for blending or mixing the polymer components together may be utilized.

The core layer may optionally comprise one or more additives. Such additives may include, but are not limited to, antioxidants (e.g., hindered phenolics, such as, IRGANOX® 1010 or IRGANOX® 1076, supplied by Ciba Geigy), phosphites (e.g., IRGAFOS® 168, also supplied by Ciba Geigy), cling additives (e.g., PIB (polyisobutylene)), Standostab PEPQ™ (supplied by Sandoz), pigments, colorants, fillers (e.g., calcium carbonate, mica, kaolin, perlite, diatomaceous earth, dolomite, magnesium carbonate, calcium sulfate, barium sulfate, glass and ceramic beads, natural and synthetic silica, aluminum trihydroxide, magnesium trihydroxide, wollastonite, whiskers, wood flour, lignine, starch), TiO₂, anti-stat additives, flame retardants, slip agents, antiblock additives, biocides, an antimicrobial agents, and clarifiers/nucleators (e.g., HYPERFORM™ HPN-20E, MILLAD™ 3988, MILLAD™ NX 8000, available from Milliken Chemical). The one or more additives can be included in the polymer blend at levels typically used in the art to achieve their desired purpose. In some examples, the one or more additives are included in amounts ranging from 0-10 wt. % of the polymer blend, 0-5 wt. % of the polymer blend, 0.001-5 wt. % of the polymer blend, 0.001-3 wt. % of the polymer blend, 0.05-3 wt. % of the polymer blend, or 0.05-2 wt. % of the polymer blend.

### First Skin Layer

In embodiments herein, the first skin layer comprises greater than 50%, by polymer weight of the first skin layer, of an ethylene-based polymer. In some embodiments, the polyethylene polymer blend comprises at least 50%, at least 55%, at least 60%, at least 65%, at least 70%, at least 75%, at least 80%, or at least 85%, by weight of the polyethylene polymer blend, of an ethylene-based polymer.

The ethylene-based polymer has a polymer backbone that lacks measurable or demonstrable long chain branches. As used herein, “long chain branching” means branches having a chain length greater than that of any short chain branches, which are a result of comonomer incorporation. The long chain branch can be about the same length or as long as the length of the polymer backbone. In some embodiments, the ethylene-based polymer is substituted with an average of from 0.01 long chain branches/1000 carbons to 3 long chain branches/1000 carbons, from 0.01 long chain branches/1000 carbons to 1 long chain branches/1000 carbons, from 0.05 long chain branches/1000 carbons to 1 long chain branches/1000 carbons. In other embodiments, the ethylene-based polymer is substituted with an average of less than 1 long chain branches/1000 carbons, less than 0.5 long chain branches/1000 carbons, or less than 0.05 long chain branches/1000 carbons, or less than 0.01 long chain branches/1000 carbons. Long chain branching (LCB) can be determined by conventional techniques known in the industry, such as ¹³C nuclear magnetic resonance (¹³C NMR) spectroscopy, and can be quantified using, for example, the method of Randall (Rev. Macromol. Chem. Phys., C29 (2 & 3), p. 285-297). Two other methods that may be used include gel permeation chromatography coupled with a low angle laser light scattering detector (GPC-LALLS), and gel permeation chromatography coupled with a differential viscometer detector (GPC-DV). The use of these techniques for long chain branch detection, and the underlying theories, have been well documented in the literature. See, for example, Zimm, B. H. and Stockmayer, W. H., J. Chem. Phys., 17, 1301 (1949) and Rudin A., Modern Methods of Polymer Characterization, John Wiley & Sons, New York (1991), pp. 103-112.

In some embodiments, the ethylene-based polymer may be a homogeneously branched or heterogeneously branched and/or unimodal or multimodal (e.g., bimodal) polyethylene. The ethylene-based polymer comprises ethylene homopolymers, copolymers of ethylene-derived units (“ethylene”) and at least one type of comonomer, and blends thereof. Examples of suitable comonomers may include α-olefins. Suitable α-olefins may include those containing 3 to 20 carbon atoms (C3-C20). For example, the α-olefin may be a C4-C20 α-olefin, a C4-C12 α-olefin, a C3-C10 α-olefin, a C3-C8 α-olefin, a C4-C8 α-olefin, or a C6-C8 α-olefin. In some embodiments, the ethylene-based polymer is an ethylene/α-olefin copolymer, wherein the α-olefin is selected from the group consisting of propylene, 1-butene, 1-pentene, 1-hexene, 4-methyl-1-pentene, 1-heptene, 1-octene, 1-nonene and 1-decene. In other embodiments, the ethylene-based polymer is an ethylene/α-olefin copolymer, wherein the α-olefin is selected from the group consisting of propylene, 1-butene, 1-hexene, and 1-octene. In further embodiments, the ethylene-based polymer is an ethylene/α-olefin copolymer, wherein the α-olefin is selected from the group consisting of 1-hexene and 1-octene. In even further embodiments, the ethylene-based polymer is an ethylene/α-olefin copolymer, wherein the α-olefin is 1-octene. In even further embodiments, the ethylene-based polymer is a substantially linear ethylene/α-olefin copolymer, wherein the α-olefin is 1-octene. In some embodiments, the ethylene-based polymer is an ethylene/α-olefin copolymer, wherein the α-olefin is 1-butene.

The ethylene/α-olefin copolymers may comprise at least 50%, for example, at least 60%, at least 70%, at least 80%, at least 90%, at least 92%, at least 95%, at least 97%, by weight, of the units derived from ethylene; and less than 30%, for example, less than 25%, less than 20%, less than 15%, less than 10%, less than 5%, less than 3%, by weight, of units derived from one or more α-olefin comonomers.

Other examples of suitable ethylene-based polymers include substantially linear ethylene polymers, which are further defined in U.S. Pat. No. 5,272,236, U.S. Pat. No. 5,278,272, U.S. Pat. No. 5,582,923 and U.S. Pat. No. 5,733,155; homogeneously branched linear ethylene polymer compositions, such as those in U.S. Pat. No. 3,645,992; heterogeneously branched ethylene polymers, such as those prepared according to the process disclosed in U.S. Pat. No. 4,076,698; and/or blends thereof (such as those disclosed in U.S. Pat. No. 3,914,342 or U.S. Pat. No. 5,854,045). In some embodiments, the ethylene-based polymer may be a linear low density (LLDPE) polymer or substantially LLDPE polymer, and may include ELITE™ or ATTANE™ resins sold by The Dow Chemical Company, including ELITE™ 5230G resin, ATTANE™ 4404 resin, or ATTANE™ 4202 resin, DOWLEX™ 2247 resin, or EXCEED™ resins sold by Exxon Mobil Corporation, including EXCEED™ 3518 resin or EXCEED™ 4518 resin, AFFINITY™ resins sold by Exxon Mobil Corporation, including AFFINITY™ 1840, and EXACT™ resins sold by Exxon Mobil Corporation, including EXACT™ 3024.

The ethylene-based polymer can be made via gas-phase, solution-phase, or slurry polymerization processes, or any combination thereof, using any type of reactor or reactor configuration known in the art, e.g., fluidized bed gas phase reactors, loop reactors, stirred tank reactors, batch reactors in parallel, series, and/or any combinations thereof. In some embodiments, gas or slurry phase reactors are used. Suitable ethylene-based polymers may be produced according to the processes described at pages 15-17 and 20-22 in WO 2005/111291 A1, which is herein incorporated by reference. The catalysts used to make the ethylene-based polymer described herein may include Ziegler-Natta, metallocene, constrained geometry, or single site catalysts. In some embodiments, the ethylene-based polymer may be a LLDPE, such as, a znLLDPE, which refers to linear polyethylene made using Ziegler-Natta catalysts, a uLLDPE or “ultra linear low density polyethylene,” which may include linear polyethylenes made using Ziegler-Natta catalysts, or a mLLDPE, which refers to LLDPE made using metallocene or constrained geometry catalyzed polyethylene.

In embodiments herein, the ethylene-based polymer has a density of 0.900-0.920 g/cc. All individual values and subranges from 0.900-0.920 g/cc are included and disclosed herein. For example, in some embodiments, the ethylene-based polymer has a density of 0.905-0.920 g/cc. In other embodiments, the ethylene-based polymer has a density of 0.910-0.920 g/cc.

In embodiments herein, the ethylene-based polymer has a melt index of 0.5-10 g/10 min. All individual values and subranges from 0.5-10 g/10 min are included and disclosed herein. For example, in some embodiments, the ethylene-based polymer has a melt index of 2-10 g/10 min. In other embodiments, the ethylene-based polymer has a melt index of 3-8 g/10 min.

The first skin layer may optionally comprise one or more additives. Such additives may include, but are not limited to, antioxidants (e.g., hindered phenolics, such as, IRGANOX® 1010 or IRGANOX® 1076, supplied by Ciba Geigy), phosphites (e.g., IRGAFOS® 168, also supplied by Ciba Geigy), cling additives (e.g., PIB (polyisobutylene)), Standostab PEPQ™ (supplied by Sandoz), pigments, colorants, fillers (e.g., calcium carbonate, mica, kaolin, perlite, diatomaceous earth, dolomite, magnesium carbonate, calcium sulfate, barium sulfate, glass and ceramic beads, natural and synthetic silica, aluminum trihydroxide, magnesium trihydroxide, wollastonite, whiskers, wood flour, lignine, starch), TiO₂, anti-stat additives, flame retardants, slip agents, antiblock additives, biocides, an antimicrobial agents, and clarifiers/nucleators (e.g., HYPERFORM™ HPN-20E, MILLAD™ 3988, MILLAD™ NX 8000, available from Milliken Chemical). The one or more additives can be included in the first skin layer at levels typically used in the art to achieve their desired purpose. In some examples, the one or more additives are included in amounts ranging from 0-10 wt. % of the first skin layer, 0-5 wt. % of the first skin layer, 0.001-5 wt. % of the first skin layer, 0.001-3 wt. % of the first skin layer, 0.05-3 wt. % of the first skin layer, or 0.05-2 wt. % of the first skin layer.

### Second Skin Layer

In embodiments herein, the second skin layer comprises greater than 50%, by polymer weight of the second skin layer, of a medium or high density polyethylene (MDPE OR HDPE). All individual values and subranges of greater than 50 wt. % are included and disclosed herein. For example, in some embodiments, the second skin layer comprises from greater than 50% to 100%, by weight of the second skin layer, of a medium or high density polyethylene. In other embodiments, the second skin layer comprises from 60 to 99%, by weight of the second skin layer, of a medium or high density polyethylene. In further, embodiments, the second skin layer comprises from 70 to 99%, by weight of the second skin layer, of a medium or high density polyethylene. In even further, embodiments, the second skin layer comprises from 80 to 99%, by weight of the second skin layer, of a medium or high density polyethylene.

The MDPE or HDPE present in the second skin layer has a density of about 0.940-0.970 g/cc. All individual values and subranges from 0.940-0.970 g/cc are included and disclosed herein. For example, in some embodiments, the MDPE or HDPE has a density of 0.940-0.965 g/cc. In other embodiments, the MDPE or HDPE has a density of 0.940-0.960 g/cc. In embodiments herein, the MDPE or HDPE present in the second skin layer has a melt index of 1-10 g/10 min. All individual values and subranges from 1-10 g/10 min are included and disclosed herein. For example, in some embodiments, the MDPE or HDPE has a melt index of 2-9 g/10 min. In other embodiments, the MDPE or HDPE has a melt index of 3-8 g/10 min. In further embodiments, the MDPE or HDPE has a melt index of 4-7 g/10 min. In even further embodiments, the MDPE or HDPE has a melt index of 1-6 g/10 min. In even further embodiments, the MDPE or HDPE has a melt index of 1-5 g/10 min.

Suitable MDPE or HDPE polymers may be produced in various commercially available continuous reaction processes, particularly, those comprising two or more individual reactors in series or parallel using slurry, solution or gas phase process technology or hybrid reaction systems (e.g. combination of slurry and gas phase reactor). Alternatively, the MDPE or HDPE polymers may also be produced by offline blending of 2 or more different polyethylene resins. For example, in some embodiments, a conventional mono-modal Ziegler-Natta MDPE or HDPE may be blended with a multi-modal Ziegler-Natta MDPE or HDPE. It is contemplated, however, that the various HDPE polymers can be produced with alternative catalyst systems, such as, metallocene, post-metallocene or chromium-based catalysts. Exemplary MDPE or HDPE resins may include resins sold by The Dow Chemical Company under the trade name HDPE 8007, HDPE 8907, HDPE 5962B, DMDA 8007 NT 7, AGILITY™ 6047G, DOWLEX™ 2028, DOWLEX™ 2027, or ELITE™ 5960G.

In embodiments herein, at least one of the first skin layer or the second skin layer may further comprise a low density polyethylene. In some embodiments, the low density polyethylene has a melt index of 0.1 to 2 g/10 min. All individual values and subranges from 0.1-2 g/10 min are included and disclosed herein, and can include, for example, from 0.1 g/10 min to 1 g/10 min, from 0.1 g/10 min to 0.98 g/10 min or from 0.2 to 0.9 g/10 min. In other embodiments, the low density polyethylene has a melt index of 2-12 g/10 min. All individual values and subranges from 2-12 g/10 min are included and disclosed herein, and can include, for example, 2-10 g/10 min or 2-8 g/10 min. In embodiments herein, the LDPE present in at least one of the first skin layer or the second skin layer may have a density of about 0.910-0.925 g/cc. All individual values and subranges from 0.910-0.925 g/cc are included and disclosed herein, and can include, for example, 0.915-0.925 g/cc or 0.916-0.922 g/cc.

In embodiments herein, the LDPE may be present in at least one of the first skin layer or the second skin layer in an amount of 1 to 15 wt. %. All individual values and subranges from 1 to 15 wt. % are included and disclosed herein. For example, in some embodiments, the LDPE may be present in at least one of the first skin layer or the second skin layer in an amount of 1 to 12 wt. %. In other embodiments, the LDPE may be present in at least one of the first skin layer or the second skin layer in an amount of 1 to 10 wt. %. In further, embodiments, the LDPE may be present in at least one of the first skin layer or the second skin layer in an amount of 1 to 8 wt. %.

The LDPE may include branched interpolymers that are partly or entirely homopolymerized or copolymerized in autoclave or tubular reactors at pressures above 14,500 psi (100 MPa) with the use of free-radical initiators, such as peroxides (see, for example U.S. Pat. No. 4,599,392, which is herein incorporated by reference). Examples of suitable LDPEs may include, but are not limited to, ethylene homopolymers, and high pressure copolymers, including ethylene interpolymerized with, for example, vinyl acetate, ethyl acrylate, butyl acrylate, acrylic acid, methacrylic acid, carbon monoxide, or combinations thereof. Exemplary LDPE resins may include resins sold by The Dow Chemical Company, such as, LDPE 722 resin, LDPE 5004 resin, LDPE 132i resin, LDPE 621i resin, LDPE 662i resin, or AGILITY™ 1000 resin. Other exemplary LDPE resins are described in WO 2005/023912, which is herein incorporated by reference.

In embodiments herein, the polymer components present in the first and/or second skin layer may be blended or mixed together. Blending or mixing can be accomplished by any suitable mixing means known in the art, including melt or dry/physical blending of the individual components. Alternatively, the polymer components may be made in a single reactor or a multiple reactor configuration, where the multiple reactors may be arranged in series or parallel, and where each polymerization takes place in solution, in slurry, or in the gas phase. It should be understood that other suitable methods for blending or mixing the polymer components together may be utilized.

The second skin layer may optionally comprise one or more additives. Such additives may include, but are not limited to, antioxidants (e.g., hindered phenolics, such as, IRGANOX® 1010 or IRGANOX® 1076, supplied by Ciba Geigy), phosphites (e.g., IRGAFOS® 168, also supplied by Ciba Geigy), cling additives (e.g., PIB (polyisobutylene)), Standostab PEPQ™ (supplied by Sandoz), pigments, colorants, fillers (e.g., calcium carbonate, mica, kaolin, perlite, diatomaceous earth, dolomite, magnesium carbonate, calcium sulfate, barium sulfate, glass and ceramic beads, natural and synthetic silica, aluminum trihydroxide, magnesium trihydroxide, wollastonite, whiskers, wood flour, lignine, starch), TiO₂, anti-stat additives, flame retardants, slip agents, antiblock additives, biocides, an antimicrobial agents, and clarifiers/nucleators (e.g., HYPERFORM™ HPN-20E, MILLAD™ 3988, MILLAD™ NX 8000, available from Milliken Chemical). The one or more additives can be included in the second skin layer at levels typically used in the art to achieve their desired purpose. In some examples, the one or more additives are included in amounts ranging from 0-10 wt. % of the second skin layer, 0-5 wt. % of the second skin layer, 0.001-5 wt. % of the second skin layer, 0.001-3 wt. % of the second skin layer, 0.05-3 wt. % of the second skin layer, or 0.05-2 wt. % of the second skin layer.

### Polyethylene-Based Composite Films

The polyethylene-based composite film may be a coextruded film. In some embodiments, the polyethylene-based film is a coextruded film, whereby at least one of the first or second skin layers is coextruded to the core layer. In other embodiments, the polyethylene-based composite film is a coextruded film, whereby a first coextruded film comprising the first skin layer coextruded to a first core layer is formed, a second coextruded film comprising the second skin layer coextruded to a second core layer is formed, and the first and second coextruded films are laminated together such that the core layers are positioned between the first and second skin layers. In further embodiments, the polyethylene-based composite film is a coextruded film, whereby the first and second skin layers are coextruded to the core layer.

In embodiments herein, the polyethylene-based composite film has an overall density of about 0.930-0.950 g/cc. All individual values and subranges from 0.930-0.950 g/cc are included and disclosed herein. For example, in some embodiments, the polyethylene-based composite film has an overall density of 0.935-0.950 g/cc. In other embodiments, the polyethylene-based composite film has an overall density of 0.935-0.945 g/cc. In further embodiments, the polyethylene-based composite film has an overall density of 0.936-0.943 g/cc. The overall density may be calculated using the following equation:

$$Overall Density = \frac{1}{( {\sum }_{i = 1}^{n} ( \frac{wt . \% of {polymer}_{i} in film}{density of {polymer}_{i} in film} ) )}$$

where the subscript “n” refers to the number of polymers in the film, “wt. % of polymerᵢ in film” is the weight % of the each polymer in the film, and density of polymerᵢ in film” is the density of each polymer in the film. As used herein, the term “polymer” refers to a polymeric compound prepared by polymerizing monomers, whether of the same or of a different type. The term “polymer” embraces the terms “homopolymer,” “copolymer,” “terpolymer,” and “interpolymer.”

In embodiments herein, the polyethylene-based composite film may have a basis weight of between about 10-20 gsm. All individual values and subranges from 10-20 gsm are included and disclosed herein. For example, in some embodiments, the polyethylene-based composite film may have a basis weight of less than 18 gsm. In other embodiments, the polyethylene-based composite film may have a basis weight of less than 16 gsm. In further embodiments, the polyethylene-based composite film may have a basis weight of between about 10-15 gsm.

In embodiments herein, the polyethylene-based composite film may exhibit a melt strength from 3-8 cN. All individual values and subranges of 3-8 cN are included and disclosed herein. For example, in some embodiments, the polyethylene-based composite film may exhibit a melt strength from 3-7.5 cN. In other embodiments, the polyethylene-based composite film may exhibit a melt strength from 3-7 cN. In further embodiments, the polyethylene-based composite film may exhibit a melt strength of greater than or equal to 2.8 cN.

In some embodiments, the polyethylene-based composite films described herein may exhibit a 5% increase in secant modulus at 2% strain in the machine direction, or a 5% increase in secant modulus at 2% strain in the cross direction, when compared to a reference polyethylene-based film that has an overall average density of about 0.939 g/cc and does not contain more than 0.01 wt. % of a low density polyethylene having a density of 0.910-0.925 g/cc and a melt index of 0.1-1 g/10 min. All individual values and subranges of a 5% increase in secant modulus at 2% strain in the machine direction and/or the cross direction are included and disclosed herein. For example, in some embodiments, the polyethylene-based composite films described herein may exhibit a 10% increase, a 12% increase, or a 15% increase in secant modulus at 2% strain in the machine direction, when compared to a reference polyethylene-based film that has an overall average density of about 0.939 g/cc and does not contain more than 0.01 wt. % of a low density polyethylene having a density of 0.910-0.925 g/cc and a melt index of 0.1-1 g/10 min. In some embodiments, the polyethylene-based composite films described herein may exhibit a 10% increase, a 15% increase, or a 20% increase in secant modulus at 2% strain in the cross direction, when compared to a reference polyethylene-based film that has an overall average density of about 0.939 g/cc and does not contain more than 0.01 wt. % of a low density polyethylene having a density of 0.910-0.925 g/cc and a melt index of 0.1-1 g/10 min.

In some embodiments, the polyethylene-based composite films described herein may exhibit a 8% increase in load at break in the machine direction, when compared to a reference polyethylene-based film that has an overall density of about 0.939 g/cc and does not contain more than 0.01 wt. % of a low density polyethylene having a density of 0.910-0.925 g/cc and a melt index of 0.1-1 g/10 min. All individual values and subranges of an 8% increase in load at break in the machine direction are included and disclosed herein. For example, in some embodiments, the polyethylene-based composite films described herein can also exhibit a 10% increase, a 15% increase, or a 20% increase in load at break in the machine direction, when compared to a reference polyethylene-based film that has an overall density of about 0.939 g/cc and does not contain more than 0.01 wt. % of a low density polyethylene having a density of 0.910-0.925 g/cc and a melt index of 0.1-1 g/10 min.

In some embodiments, the polyethylene-based composite films described herein may exhibit a 10% decrease in strain % in the machine direction, and a 15% increase in strain % in the cross direction, when compared to a reference polyethylene-based film that has an overall density of about 0.939 g/cc and does not contain more than 0.01 wt. % of a low density polyethylene having a density of 0.910-0.925 g/cc and a melt index of 0.1-1 g/10 min. All individual values and subranges of a 10% decrease in strain % in the machine direction and/or a 15% increase in strain % in the cross direction are included and disclosed herein. For example, in some embodiments, the polyethylene-based composite films described herein may exhibit a 15% decrease, a 20% decrease, a 25% decrease, a 35% decrease, a 40% decrease, or a 45% decrease in strain % in the machine direction, when compared to a reference polyethylene-based film that has an overall density of about 0.939 g/cc and does not contain more than 0.01 wt. % of a low density polyethylene having a density of 0.910-0.925 g/cc and a melt index of 0.1-1 g/10 min. In some embodiments, the polyethylene-based composite films described herein may exhibit a 20% increase, a 25% increase, or a 30% increase in strain % in the cross direction, when compared to a reference polyethylene-based film that has an overall density of about 0.939 g/cc and does not contain more than 0.01 wt. % of a low density polyethylene having a density of 0.910-0.925 g/cc and a melt index of 0.1-1 g/10 min.

The % increase or % decrease may be calculated as follows:

$$\frac{\begin{matrix}\vert [ measured value of comparative film ] - \\ [ measured value of inventive film ] \vert\end{matrix}}{( measured value of comparative film )} \times 100 \%$$

Without being bound by theory, it is believed that one or more of the foregoing improvement in properties result from incorporating a branched, higher molecular weight low density polyethylene in the core layer, which can increase the film stiffness (e.g., load at break) and the melt strength. In addition, it is believed that one or more of the foregoing improvement in properties also result from including an ethylene-based polymer having a density of 0.900-0.920 g/cc and a melt index of 1-10 g/10 min in the first skin layer, which increases strain in the cross-direction.

### Laminates

Also described herein are laminate structures. The laminate structures comprise a polyethylene-based composite film as previously described herein, and a nonwoven substrate at least partially bonded to the polyethylene-based composite film. As used herein, “nonwoven substrates” include nonwoven webs, nonwoven fabrics and any nonwoven structure in which individual fibers or threads are interlaid, but not in a regular or repeating manner. Nonwoven substrates described herein may be formed by a variety of processes, such as, for example, air laying processes, meltblowing processes, spunbonding processes and carding processes, including bonded carded web processes.

In embodiments herein, the nonwoven substrate is made from a propylene-based material. Examples of suitable propylene-based materials include materials that comprise a majority weight percent of polymerized propylene monomer (based on the total amount of polymerizable monomers), and optionally, one or more comonomers. This may include propylene homopolymer (i.e., a polypropylene), a propylene copolymer, or combinations thereof. The propylene copolymer may be a propylene/olefin copolymer. Nonlimiting examples of suitable olefin comonomers include ethylene, C₄-C₂₀ α-olefins, such as 1-butene, 1-pentene, 1-hexene, 4-methyl-1-pentene, 1-heptene, 1-octene, 1-decene, or 1-dodecene. In some embodiments, the propylene-based material is polypropylene homopolymer.

The embodiments described herein may be further illustrated by the following non-limiting examples.

### Test Methods

Unless otherwise stated, the following test methods are used.

### Density

Densities disclosed herein for ethylene-based polymers are determined according to ASTM D-792.

### Melt Index

Melt index, or I₂, is determined according to ASTM D1238 at 190° C., 2.16 kg.

### Melt Strength

Melt Strength measurements are conducted on a Gottfert Rheotens 71.97 (Göettfert Inc.; Rock Hill, S.C.) attached to a Gottfert Rheotester 2000 capillary rheometer. A polymer melt (about 20-30 grams, pellets) is extruded through a capillary die with a flat entrance angle (180 degrees) with a capillary diameter of 2.0 mm and an aspect ratio (capillary length/capillary diameter) of 15. After equilibrating the samples at 190° C. for 10 minutes, the piston is run at a constant piston speed of 0.265 mm/second. The standard test temperature is 190° C. The sample is drawn uniaxially to a set of accelerating nips located 100 mm below the die, with an acceleration of 2.4 mm/second². The tensile force is recorded as a function of the take-up speed of the nip rolls. Melt strength is reported as the plateau force (cN) before a strand breaks. The following conditions are used in the melt strength measurements: plunger speed=0.265 mm/second; wheel acceleration=2.4 mm/s²; capillary diameter=2.0 mm; capillary length=30 mm; and barrel diameter=12 mm.

### Secant Modulus @ 2% Strain

Secant modulus at 2% strain is measured in accordance with ASTM D882.

### Load at Break

Load at break is measured in accordance with ASTM D882.

### Strain

The percent strain is measured in accordance with ASTM D882.

### Examples

The following materials are used in the Example described below.

### Preparation of Inventive Films

Three layer films were made as outlined below. The films were produced on a pilot line on an ABC structure at 21 m/min using a die temperature of 230° C., a chill temperature of 16° C., a melt temperature of 220° C., and a die gap of 0.8 mm. The polyethylene-based composite films had a basis weight was 15 gsm. The materials used in the inventive films include:
HDPE 1 is a high density polyethylene having a density of approximately 0.943 g/cc and a melt index of approximately 6.0 g/10 min
HDPE 2 is a high density polyethylene having a density of approximately 0.958 g/cc and a melt index of approximately 5.0 g/10 min
HDPE 3 is a high density polyethylene having a density of approximately 0.947 g/cc and a melt index of approximately 6.0 g/10 min
EBP is an ethylene-octene copolymer having a density of 0.916 g/cc and a melt index of 4.0 g/10 min (ELITE™ 5230G from The Dow Chemical Company, USA).
LDPE 1 is a low density polyethylene having a density of approximately 0.919 g/cc and a melt index of approximately 0.47 g/10 min
LDPE 2 is a low density polyethylene having a density of approximately 0.921 g/cc and a melt index of approximately 0.25 g/10 min
LDPE 3 is a low density polyethylene having a density of approximately 0.918 g/cc and a melt index of approximately 7 g/10 min.

Inventive Film 1

| | First Skin | | Second Skin | |
|---|---|---|---|---|
| | Layer A | Core B | Layer C | |
| | (wt. %) | (wt. %) | (wt. %) | Film |
| Thickness | 20% of | 60% of | 20% of | |
| | Overall Film | Overall Film | Overall Film | |
| HDPE 1 | 0 | 0 | 0 | |
| HDPE 2 | 0 | 0 | 0 | |
| HDPE 3 | 87 | 80 | 87 | |
| EBP | 0 | 0 | 0 | |
| LDPE 1 | 0 | 0 | 0 | |
| LDPE 2 | 0 | 20 | 0 | |
| LDPE 3 | 13 | 0 | 13 | |
| Calculated | | | | 0.9391 |
| Overall Density | | | | |

Inventive Film 2

| | First Skin | | Second Skin | |
|---|---|---|---|---|
| | Layer A | Core B | Layer C | |
| | (wt. %) | (wt. %) | (wt. %) | Film |
| Thickness | 20% of | 60% of | 20% of | |
| | Overall Film | Overall Film | Overall Film | |
| HDPE 1 | 0 | 95 | 0 | |
| HDPE 2 | 0 | 0 | 95 | |
| HDPE 3 | 0 | 0 | 0 | |
| EBP | 95 | 0 | 0 | |
| LDPE 1 | 5 | 5 | 5 | |
| LDPE 2 | 0 | 0 | 0 | |
| LDPE 3 | 0 | 0 | 0 | |
| Calculated | | | | 0.9395 |
| Overall Density | | | | |

Inventive Film 3

| | First Skin | | Second Skin | |
|---|---|---|---|---|
| | Layer A | Core B | Layer C | |
| | (wt. %) | (wt. %) | (wt. %) | Film |
| Thickness | 20% of | 60% of | 20% of | |
| | Overall Film | Overall Film | Overall Film | |
| HDPE 1 | 0 | 85 | 0 | |
| HDPE 2 | 0 | 0 | 95 | |
| HDPE 3 | 0 | 0 | 0 | |
| EBP | 95 | 0 | 0 | |
| LDPE 1 | 5 | 15 | 5 | |
| LDPE 2 | 0 | 0 | 0 | |
| LDPE 3 | 0 | 0 | 0 | |
| Calculated | | | | 0.9381 |
| Overall Density | | | | |

Inventive Film 4

| | First Skin | | Second Skin | |
|---|---|---|---|---|
| | Layer A | Core B | Layer C | |
| | (wt. %) | (wt. %) | (wt. %) | Film |
| Thickness | 20% of | 50% of | 30% of | |
| | Overall Film | Overall Film | Overall Film | |
| HDPE 1 | 0 | 83 | 0 | |
| HDPE 2 | 0 | 0 | 95 | |
| HDPE 3 | 0 | 0 | 0 | |
| EBP | 95 | 0 | 0 | |
| LDPE 1 | 5 | 17 | 5 | |
| LDPE 2 | 0 | 0 | 0 | |
| LDPE 3 | 0 | 0 | 0 | |
| Calculated | | | | 0.9395 |
| Overall Density | | | | |

### Preparation of Comparative Film

A three layer film was made as outlined below. The film was produced on a pilot line on an ABC structure at 21 m/min using a die temperature of 230° C., a chill temperature of 16° C., a melt temperature of 220° C., and a die gap of 0.8 mm. The polyethylene-based composite films had a basis weight was 15 gsm. The materials used in the comparative film include:

HDPE is a high density polyethylene having a density of approximately 0.943 g/cc and a melt index of approximately 6.0 g/10 min.

LDPE is a low density polyethylene having a density of approximately 0.918 g/cc and a melt index of approximately 7 g/10 min.

Comparative Film A

| | First Skin | | Second Skin | |
|---|---|---|---|---|
| | Layer A | Core B | Layer C | |
| | (wt. %) | (wt. %) | (wt. %) | Film |
| Thickness | 20% of | 40% of | 40% of | |
| | Overall Film | Overall Film | Overall Film | |
| HDPE | 87 | 87 | 87 | |
| LDPE | 13 | 13 | 13 | |
| Calculated | | | | 0.9398 |
| Overall Density | | | | |

### Results

TABLE 1
Tensile Results

| | 2% Secant | Secant | Load at | Load at | | |
|---|---|---|---|---|---|---|
| | Modulus | Modulus | Break | Break | Strain | Strain |
| | MD | 2% CD | MD | CD | MD | CD |
| Description | (MPa) | (MPa) | (MPa) | (MPa) | (%) | (%) |
| Comparative | 600 | 597 | 19.9 | 13.2 | 488 | 514 |
| Film A | | | | | | |
| Inventive Film | 706 | 743 | 35.8 | 13.3 | 132 | 192 |
| 1 | | | | | | |
| Inventive Film | 613 | 617 | 22.1 | 13.1 | 408 | 615 |
| 2 | | | | | | |
| Inventive Film | 626 | 695 | 23.6 | 12.3 | 252 | 700 |
| 3 | | | | | | |
| Inventive Film | 692 | 741 | 24.6 | 13.1 | 280 | 675 |
| 4 | | | | | | |

TABLE 2
Melt Strength Results

| | Melt Strength |
|---|---|
| Description | (cN) |
| Comparative Film A | 2.74 |
| Inventive Film 1 | 2.80 |
| Inventive Film 2 | 5.50 |
| Inventive Film 3 | 5.73 |
| Inventive Film 4 | 6.53 |

### Secant Modulus @ 2% Strain Test Results

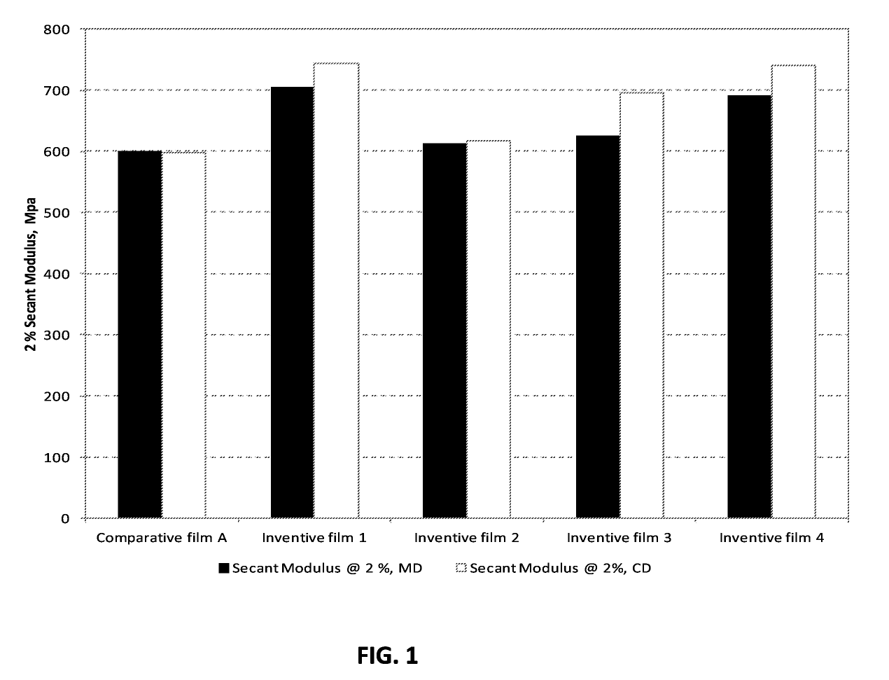

Referring to FIG. 1 & Table 1, depicted is a comparison of the secant modulus measured for the four inventive films and the comparative film. The inventive films 1, 2, 3, & 4, all of which incorporate a low density polyethylene having a density of 0.910-0.925 g/cc and a melt index of 0.1-1 g/10 min in the core layer, show an increase in the secant modulus in both the machine direction and the cross direction over comparative film A.

### Load at Break Test Results

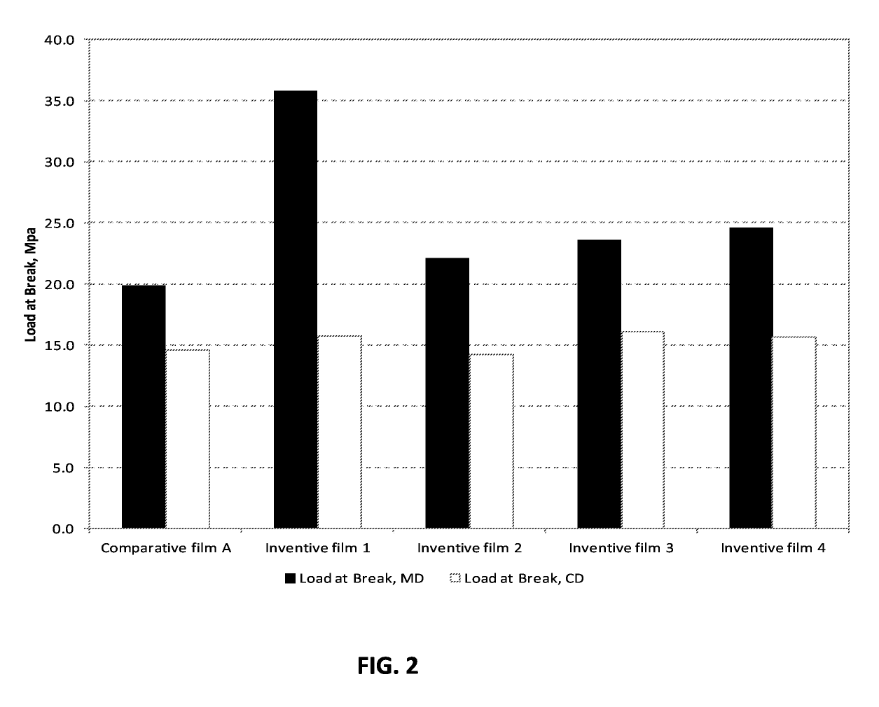

Referring to FIG. 2 & Table 1, depicted is the load at break in the machine direction (MD) and cross direction (CD) for the four inventive films and the comparative film. As shown, the inventive films, all of which incorporate a low density polyethylene having a density of 0.910-0.925 g/cc and a melt index of 0.1-1 g/10 min in the core layer, show an increase in load at break in the machine direction over comparative film A.

### % Strain Results

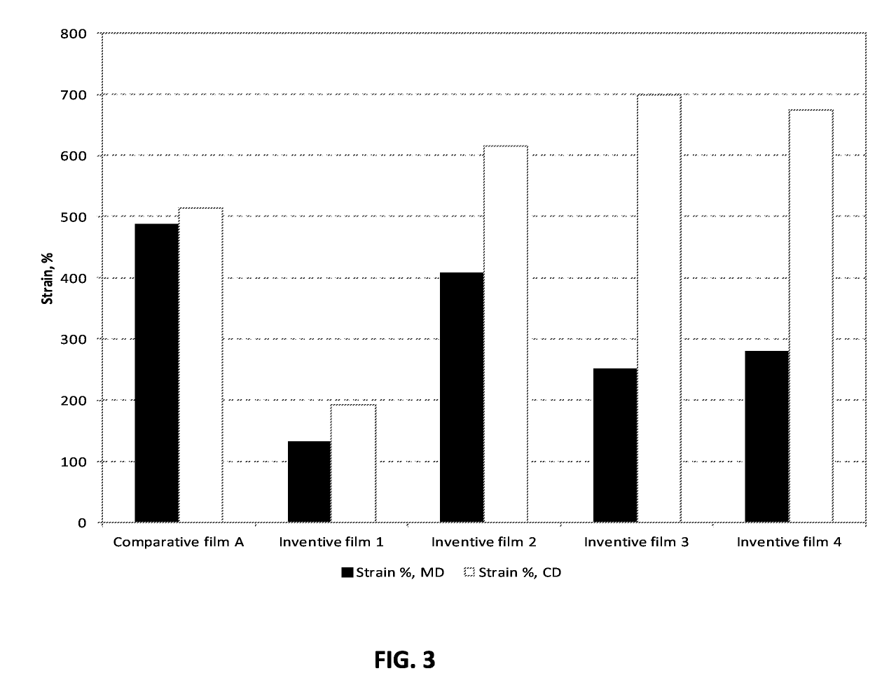

Referring to FIG. 3 & Table 1, the percent strain was measured in the machine direction (MD) and cross direction (CD) for the four inventive films and the comparative film. As shown, an increase was observed in strain % in the cross direction was observed for inventive films 2, 3, & 4 over comparative film A. Inventive film 1, which does not include an ethylene-based polymer having a density of 0.900-0.920 g/cc and a melt index of 1-10 g/10 min, does not show an increase in strain, which may be useful in certain applications. In the machine direction, a decrease in strain % was observed in the inventive films compared to comparative film A.

### Melt Strength Results

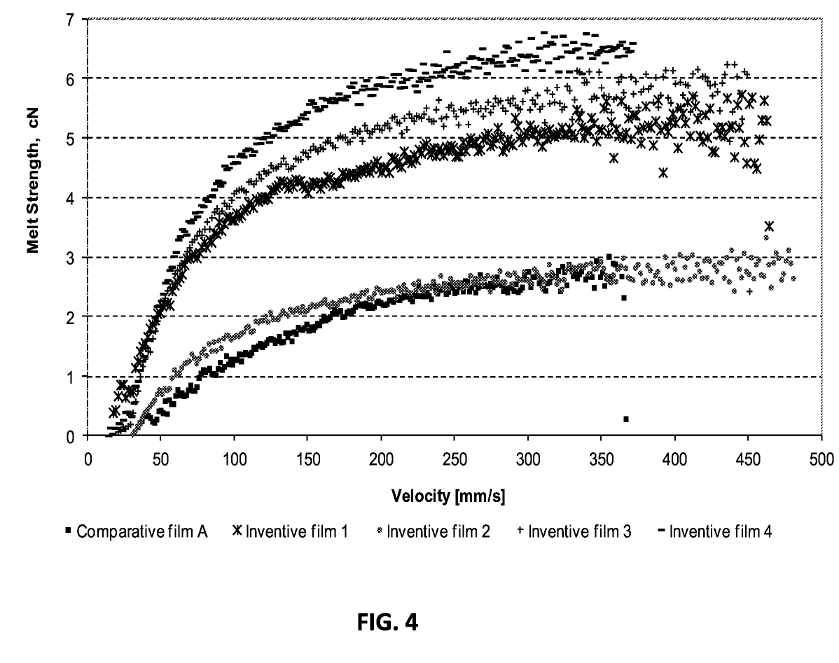

Referring to FIG. 4 & Table 2, the melt strength was determined for the four inventive films and the comparative film. As shown, the melt strength increased for the four inventive films and the comparative films.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A polyethylene-based composite film for use in absorbent articles, the film comprising: a core layer, a first skin layer and a second skin layer, the core layer being positioned between the first skin layer and the second skin layer;
wherein the core layer comprises a polymer blend, the polymer blend comprising:
a medium or high density polyethylene resin having a density of 0.940-0.970 g/cc and a melt index of 1-10 g/10 min, and
a low density polyethylene having a density of 0.910-0.925 g/cc and a melt index of 0.1-2 g/10 min; and
wherein the polyethylene-based composite film has an overall density of 0.930-0.950 g/cc.

2. The film of claim 1, wherein the polymer blend comprises 5 wt. % to 25 wt. % of the low density polyethylene.

3. The film of claim 1, wherein the first skin layer comprises greater than 50%, by polymer weight of the first skin layer, of an ethylene-based polymer comprising greater than 50 mol. % units derived from ethylene, and wherein the ethylene-based polymer has a density of 0.900-0.920 g/cc and a melt index of 1-10 g/10 min.

4. The film of claim 1, wherein the second skin layer comprises greater than 50%, by polymer weight of the second skin layer, of a medium or high density polyethylene having a density of about 0.940-0.970 g/cc and a melt index of 1-10 g/10 min.

5. The film of claim 1, wherein at least one of the first skin layer or the second skin layer further comprises a low density polyethylene.

6. The film of claim 5, wherein the low density polyethylene present in the at least one of the first skin layer or the second skin layer has a melt index of 0.1 to 2 g/10 min.

7. The film of claim 5, wherein the low density polyethylene present in the at least one of the first skin layer or the second skin layer has a melt index of 2-12 g/10 min.

8. The film of claim 1, wherein the core layer comprises from about 50% to about 90% of the overall film thickness.

9. The film of claim 1, wherein the first skin layer and the second skin layer have an unequal thickness.

10. The film of claim 1, wherein the polyethylene-based composite film has a basis of weight of 10-20 gsm.

11. A laminate structure comprising a substrate adhered to a polyethylene-based composite film according claim 1.
